(19) United States
(12) Patent Application Publication
(10) Pub. No.: US 2005/0092218 A1
(43) Pub. Date: May 5, 2005

(54) Concealed storage system

(76) Inventors: Mike Saucier, Perkinston, MS (US); Grady Floyd, Biloxi, MA (US)

Correspondence Address: JUAN J. LIZARRAGA, 909 POYDRES STREET, SUITE 2300, NEW ORLEANS, LA, 70112-1010, US

(21) Appl. No.: 10/647,524

(22) Filed: Aug. 25, 2003

(51) Int. Cl. E05G 1/00

(52) U.S. Cl. 109/1 S

(57) ABSTRACT

A concealed storage system and method for storage of valuable objects and other equipment in a subsurface location beneath the floor of a structure and also for emergency shelter in the event of a disaster such as a storm or tornado. The system includes an encased chamber below the floor of a structure with an opening in the floor, a support frame fixed in the chamber, a liftable frame within the support frame with a top and bottom deck and a mechanism for raising and lowering the liftable frame. The liftable frame may also include a safe and a storage compartment as well as space on the lower deck for storage of other equipment. The top deck may also include an escape hatch to allow egress from the system when the liftable frame is in its lowered position.

### BACKGROUND OF THE INVENTION

The homeowner and business owner alike often find it difficult to provide a safe and secure location for valuable possessions on site, whether it be home or business. Likewise, property owners must give up usable floor space for the storage of equipment whether it be rolling items such as lawn mowers, golf carts, bicycles, motorcycles and forklift trucks, or stationary items such as files, or office equipment. Another difficulty the property owner may face is the need for emergency shelter from disasters such as tornados.

Safes or vaults are available for the storage of valuable possessions such as jewelry, and firearms but these devices are stationary and generally accessible by entrance into a structure. In addition, safes and vaults also take up floor space usable for other day-to-day activities. Thus, while a property owner may desire to safely store many items, the size and floor space necessary may be prohibitive and a vault of sufficient size would be difficult to conceal and thereby make a tempting target for a burglar. The alternative is to rent offsite storage in a bank vault with limited availability and access.

In addition to the need for secure storage of valuable items, many property owners have limited space to store the many items associated with maintaining property such as rolling lawn equipment or items for recreational use such as golf carts. This is particularly true for residential communities built around a golf course. Hence there is a need for larger garages and other storage buildings. This may be impossible or impractical in existing or planned structures because of a lack of available ground space.

Along with the need for secure storage of valuables and more space for storage of equipment, property owners in many parts of the country need a safe haven or shelter in the event of some catastrophic event such as a tornado which can destroy even the sturdiest of buildings.

### SUMMARY OF THE INVENTION

It is an object of this invention to provide a new and improved concealed storage system and method which will address and solve several important needs of the residential and commercial property owner in a way more convenient and economical than any solutions available to address these needs on an individual basis. It is an object of this invention to provide concealed storage below the floor of a structure for valuables and other equipment as well as a safe haven for protection from disasters such as storms and tornadoes, all in one system or method which can be readily and conveniently used by the owner. It is a further object of this invention, that the system or method be equally applicable to existing or new construction and that the system be designed to the size and with the features desired by the owner.

In accordance with the foregoing and other objectives of the invention, a new concealed storage system is provided comprising; a) an encased chamber below a floor of a structure having an opening in the floor above the chamber; b) a support frame fixed in the chamber; c) a liftable frame within the support frame, said liftable frame further comprising a top deck and a bottom deck; d) a mechanism for vertically raising and lowering the liftable frame through the opening in the floor. In one embodiment of the concealed storage system, the top deck further comprises an emergency exit hatch and ladder and the bottom deck comprises an access hatch. In a preferred embodiment of the invention, the top deck of the liftable frame is of size and shape to cover the opening in the floor when the liftable frame is vertically lowered fully in the support frame and wherein the bottom deck of the liftable frame is even with the floor when the liftable frame is vertically raised fully in the support frame and is of size and shape to receive rolling equipment from the floor when the bottom deck is even with the floor.

In a preferred embodiment, the chamber shall be encased in suitable construction material such as reinforced concrete or steel, but it is not intended that such encasement be limited to those materials. In addition, the chamber shall be fitted with suitable ventilation piping and sump pump connection where required by the soil and ground conditions surrounding the chamber.

In a further embodiment of the concealed storage system, the liftable frame further comprises a front end, a rear end, a right side and a left side and further comprises a safe with a locking door mounted between the bottom deck and the upper deck at the rear end of the liftable frame with the locking door facing the rear end of the liftable frame and accessible from the floor at the rear end of the liftable frame when the liftable frame is vertically raised fully in the support frame and the bottom deck is even with the floor, and further comprising a storage compartment with a hinged door mounted between the bottom deck and the upper deck at the rear end of the liftable frame with the hinged door facing the rear end of the liftable frame with the hinged door facing the rear end of the liftable frame and accessible from the floor at the rear end when the liftable frame is vertically raised fully in the support frame and the bottom deck is even with the floor.

In a further embodiment of the concealed storage system, the mechanism for vertically raising and lowering the liftable frame through the opening in the floor further comprises a motor driving a roller chain and sprocket assembly, at least one lifting screw shaft driven by the roller chain and sprocket assembly and one ball screw nut affixed to the liftable frame for each lifting screw shaft wherein said ball screw nut is driven a vertical direction by the lifting screw shaft. In another embodiment, the mechanism for vertically raising and lowering the liftable frame through the opening in the floor further comprises a primary drive shaft being rotated by the motor through a belt and pulley assembly, the primary drive shaft driving the roller chain and sprocket assembly. It is not intended that the motor be limited to electric power but could also be powered hydraulically or pneumatically.

In an alternative embodiment of the concealed storage system, the mechanism for vertically raising and lowering the liftable frame through the opening in the floor comprises at least one hydraulic cylinder and piston assembly activated by hydraulic fluid energized by at least one motor drive pump.

In an alternative embodiment of the concealed storage system, the mechanism for vertically raising and lowering the liftable frame through the opening in the floor comprises at least one rack and pinion elevating system with a pinion driven by at least one motor driven electrically, hydraulically or pneumatically.

In an alternative embodiment of the concealed storage system, the mechanism for vertically raising and lowering the liftable frame through the opening in the floor comprises a cable and pulley system being driven by at least one motor driven electrically, hydraulically or pneumatically.

It is an object of this invention that the mechanism for vertically raising and lowering the liftable frame through the opening in the floor have at least one control switch within the liftable frame and at least one control switch external to the liftable frame.

It is also an object of the present invention to provide a method for creating a concealed storage system by a) excavating and encasing a chamber below a floor in a structure with an opening in said floor; b) fabricating and fixing a support frame in the chamber; c) fabricating and installing a liftable frame with a top deck and a bottom deck to travel vertically in the support frame; d) providing and installing a mechanism for vertically raising and lowering the liftable frame in the support frame through the opening in the floor. A preferred embodiment of this method further comprises the step of installing an emergency exit hatch with ladder in the top deck and the step of installing an access hatch in the bottom deck. A preferred embodiment of the method further comprises the step of fabricating and installing a liftable frame wherein the top deck is of size and shape to cover the opening in the floor when the liftable frame is vertically lowered fully in the support frame and wherein the bottom deck of the liftable frame is even with the floor when the liftable frame is vertically raised fully in the support frame and is of size and shape to receive rolling equipment from the floor when the bottom deck is even with the floor.

A preferred embodiment of this method further comprises the step of fabricating and installing the liftable frame comprising a front end, a rear end, a right side and a left side and further comprises installing a safe with a locking door mounted between the bottom deck and the upper deck at the rear end of the liftable frame with the locking door facing the rear end of the liftable frame and accessible from the floor at the rear end of the liftable frame when the liftable frame is vertically raised fully in the support frame and the bottom deck is even with the floor, and further comprising installing a storage compartment with a hinged door mounted between the bottom deck and the upper deck at the rear end of the liftable frame with the hinged door facing the rear end of the liftable frame with the hinged door facing the rear end of the liftable frame and accessible from the floor at the rear end when the liftable frame is vertically raised fully in the support frame and the bottom deck is even with the floor.

In a further embodiment of the method, the mechanism provided and installed for vertically raising and lowering the liftable frame through the opening in the floor further comprises a motor driving a roller chain and sprocket assembly, at least one lifting screw shaft driven by the roller chain and sprocket assembly and one ball screw nut affixed to the liftable frame for each lifting screw shaft wherein said ball screw nut is driven a vertical direction by the lifting screw shaft. In another embodiment, the mechanism provided and installed for vertically raising and lowering the liftable frame through the opening in the floor further comprises a primary drive shaft being rotated by the motor through a belt and pulley assembly, the primary drive shaft driving the roller chain and sprocket assembly.

In an alternative embodiment of the method, the mechanism provided and installed for vertically raising and lowering the liftable frame through the opening in the floor further comprises at least one hydraulic cylinder and piston assembly activated by hydraulic fluid energized by at least one motor drive pump.

In an alternative embodiment of the method, the mechanism provided and installed for vertically raising and lowering the liftable frame through the opening in the floor comprises a cable and pulley system being driven by at least one motor driven electrically, hydraulically or pneumatically.

In an alternative embodiment of the method, the mechanism provided and installed for vertically raising and lowering the liftable frame through the opening in the floor comprises at least one rack and pinion elevating system with a pinion driven by at least one motor driven electrically, hydraulically or pneumatically.

In a further embodiment of the method, the mechanism for vertically raising and lowering the liftable frame through the opening in the floor comprises at least one control switch within the liftable frame and at least one control switch external to the liftable frame.

### BRIEF DESCRIPTION OF THE DRAWINGS

FIG. 1 is a perspective view of a concealed storage system in an elevated position.

FIG. 2 is a side view of a support frame set in an encased chamber with a partially elevated liftable frame.

FIG. 3 is a sectional view as taken along line 3-3 of FIG. 2.

FIG. 4 is a sectional view as taken along line 4-4 of FIG. 2.

FIG. 5 is a sectional view as taken along line 5-5 of FIG. 2.

FIG. 6 is a sectional view as taken along line 6-6 of FIG. 5.

FIG. 7 is a sectional view as taken along line 7-7 of FIG. 6.

FIG. 8 is a sectional view as taken along line 8-8 of FIG. 5.

FIG. 9 is a sectional view as taken along line 9-9 of FIG. 8.

FIG. 10 is a sectional view as taken along line 10-10 of FIG. 8.

FIG. 11 is a view as taken along line 11-11 of FIG. 8.

FIG. 12 is a sectional view as taken along line 12-12 of FIG. 11.

FIG. 13 is a sectional view as taken along line 13-13 of FIG. 6.

FIG. 14 is a sectional view as taken along line 14-14 of FIG. 7.

FIG. 15 is an additional sectional view as taken along line 4-4 of FIG. 2.

### DETAILED DESCRIPTION OF THE INVENTION

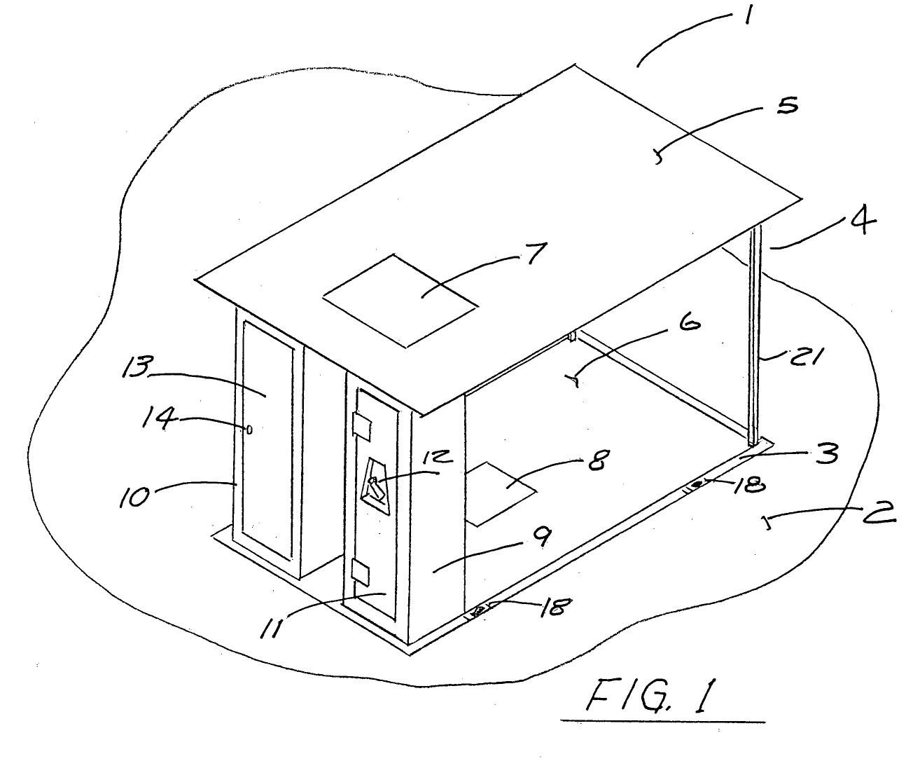

A preferred embodiment of a concealed storage system 1 in an elevated position is generally illustrated in perspective in FIG. 1. As shown in FIG. 1, the concealed storage system 1 is fully elevated such the liftable frame 4 is in its highest position and the bottom deck 6 of the liftable frame 4 is even with the floor 2 of a structure which is not shown in its entirety. The liftable frame 4 is elevated through an opening 3 in the floor 2. In the concealed position, the liftable frame 4 is lowered such the top deck 5 would cover the opening 3 and be flush with the floor 2. The top deck is shown with an emergency exit hatch 7 which would allow persons on the bottom deck 6 to exit the storage system when the liftable frame 4 is lowered and power was unavailable to raise the liftable frame 4. The bottom deck 6 is fitted with an access hatch 8 to allow access to the lifting mechanism which is not shown in FIG. 1 other than by ball screw nuts 18 affixed to the liftable frame 4 and upon which the liftable frame 4 is driven in a vertical direction in this embodiment. FIG. 1 further illustrates a support column 21 for the front end of the liftable frame 4, as well as a safe 9 and a storage compartment 10. The safe 9 has a locking door 11 with a recessed lock 12 and the storage compartment 10 has a hinged door 13 with a tubular key lock 14. A preferred material for the top deck 5, the bottom deck 6, the safe 9 and the storage compartment 10 is steel plate. As an alternative, aluminum plate could be used.

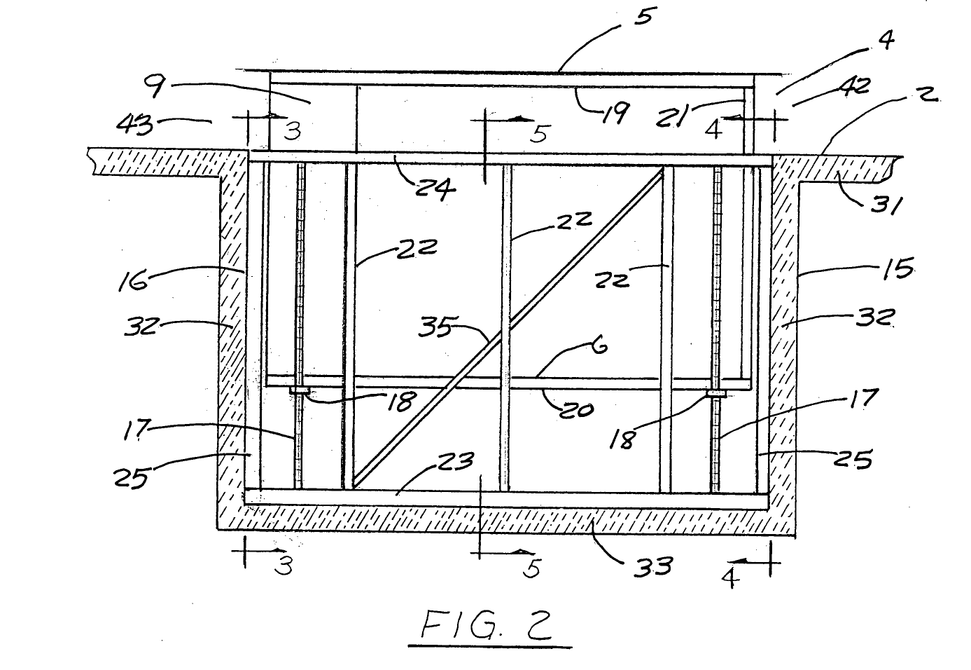

A side view of a support frame 16 for a concealed storage system 1 is shown in FIG. 2. Also shown in FIG. 2 is a partially elevated liftable frame 4. The support frame 16 is set in an encased chamber 15 which is sized to receive the support frame 16 through an opening 3 in the floor 2 as depicted in FIG. 1. The floor 2 as shown in cross section in FIG. 2 is depicted as being a slab 31, typically of reinforced concrete and the encased chamber 15 is also depicted as being of material similar to the floor with chamber end structure 32 and chamber bottom structure 33. Although reinforced concrete would be a preferred material for the encased chamber 15, other materials such as structural steel plate could be used as well.

The various side members of the support frame 16 depicted in FIG. 2 comprise side columns 22, a bottom side beam 23, a top side beam 24, corner columns 25, and a side diagonal beam 35. A preferred material for these members is structural steel tubing of square or rectangular cross section or other structural steel shapes such as angles or channel. As an alternative, structural aluminum members could be used.

Also shown in FIG. 2 are lifting screw shafts 17 which comprise elements of a mechanism for raising and lowering the liftable frame 4 through the opening 3 in the floor 2. In this embodiment there are shown two (2) lifting screw shafts 17 on each side of the support frame 16 for a total of four (4) lifting screw shafts 17. It is understood that in other embodiments there may be fewer or more than four (4) lifting screw shafts 17 depending upon the lifting capacity required. As the lifting screw shafts rotate, ball screw nuts 18 affixed to the liftable frame 4 raise or lower depending on the direction of rotation of the lifting screw shafts 17, thereby raising or lowering the liftable frame 4 to which the ball screw nuts 18 are affixed. As shown in FIG. 2, the ball screw nuts 18 are affixed to a bottom deck longitudinal beam 20 which partially supports the bottom deck 6. The lifting screw shafts 17 offer the advantage of being self-locking upon disengagement of power. The inventors have discovered that the lifting screw shafts 17 work more effectively and in a smoother fashion if the lifting screw shafts 17 are supported or suspended from the top side beam 24. Although not shown, the support frame side column 22 can serve as a guide for steadying rollers affixed to the bottom deck longitudinal beam 20, which rollers prevent longitudinal and sideways motion in the liftable frame 4 when being raised or lowered. Likewise not shown are alternative means for guiding and steading the liftable frame 4 when being raised or lowered. Such alternative means may be at least one vertical guiding rod affixed in the support frame 16 with a bushing affixed to the liftable frame 4 and riding on the vertical guiding rod. Another alternative means may be at least one set of telescoping tubes with a vertical receiving tube affixed to either the support frame 16 or the liftable frame 4 and a vertical tube riding in the receiving tube and affixed to either the liftable frame 4 or support frame 16 depending on the fixity of the receiving tube.

Various elements of the partially elevated liftable frame 4 as seen from a side view are also depicted in FIG. 2. A top deck longitudinal beam 19 is shown as partially supporting the top deck 5. Also shown is a support column 21 for the front end 42 of the liftable frame 4 and a safe 9 at the rear end 43 of the liftable frame 4. A preferred material for top deck longitudinal beam 19, bottom deck longitudinal beam 20 and support column 21 is structural steel tubing of square or rectangular cross section or other structural steel shapes such as angles or channel. As an alternative, structural aluminum members could be used.

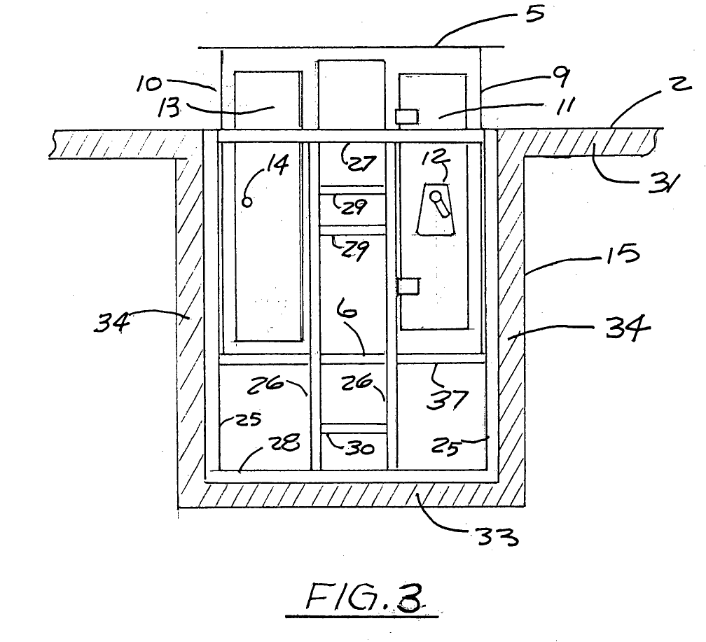

FIG. 3, a sectional view as taken along line 3-3 of FIG. 2 depicts the various members of the support frame 16 at its rear end corresponding to the rear end 43 of the liftable frame 4, which is also depicted in FIG. 3 in a partially elevated position. Shown are corner columns 25, rear end columns 26, a rear top end beam 27, rear bottom end beam 28, motor support beams 29 and a gear reduction support beam 30. A preferred material for these members is structural steel tubing of square or rectangular cross section or other structural steel shapes such as angles or channel. As an alternative, structural aluminum members could be used.

The floor 2 and encased chamber 15 are also shown in section in FIG. 3 with a floor slab 31, chamber side structure 34 and chamber bottom structure 33.

Various elements of the partially elevated liftable frame 4 as seen from the rear end are also depicted in FIG. 3. Shown is a transverse beam 37 partially supporting the bottom deck 6, the top deck 5 supported at the rear end by a safe 9 with a locking door 11 and a recessed lock 12, as well as a storage compartment 10 with a hinged door 13 and a tubular key lock 14.

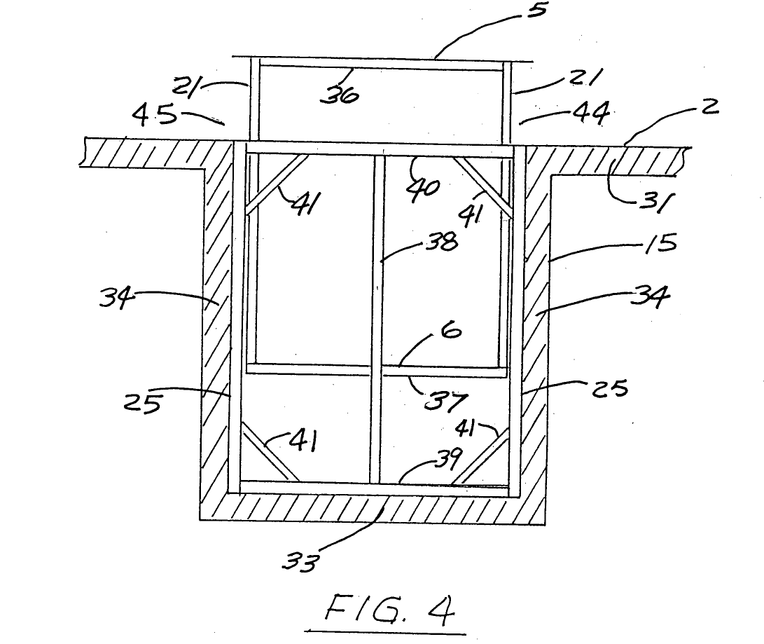

FIG. 4, a sectional view as taken along line 4-4 of FIG. 2 depicts the various members of the support frame 16 at its front end corresponding to the front end 42 of the liftable frame 4, which is also depicted in FIG. 4 in a partially elevated position. Shown are corner columns 25, front end column 38, a front top end beam 40, front bottom end beam 39, and front end diagonal beams 41. A preferred material for these members is structural steel tubing of square or rectangular cross section or other structural steel shapes such as angles or channel. As an alternative, structural aluminum members could be used.

The floor 2 and encased chamber 15 are also shown in section in FIG. 4 with a floor slab 31, with chamber side structure 34 and chamber bottom structure 33.

Various elements of the partially elevated liftable frame 4 as seen from the front end are also depicted in FIG. 4. Shown is a transverse beam 37 partially supporting the bottom deck 6, and front end support columns 21 and transverse beam 36 partially supporting the top deck 5.

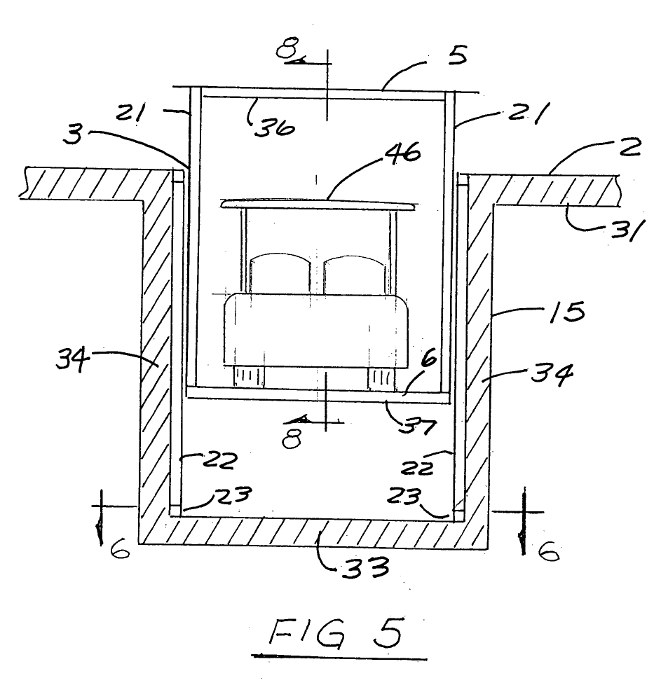

FIG. 5, a sectional view taken along line 5-5 of FIG. 2, depicts a cross sectional view of the concealed storage system 1 with the support frame 16 in place in the encased chamber 15 and the liftable frame 4 in a partially elevated position in the opening 3 of the floor 2 of a structure. This sectional view shows the side columns 22 for the support frame 16 as well as the bottom side beams 23 and the top side beams 24 for the support frame 16.

The floor 2 and encased chamber 15 are also shown in section in FIG. 5 with a floor slab 31, with chamber side structure 34 and chamber bottom structure 33.

Various elements of the partially elevated liftable frame 4 as seen in cross section are also depicted in FIG. 5. Shown is a transverse beam 37 partially supporting the bottom deck 6, and front end support columns 21 and transverse beam 36 partially supporting the top deck 5. A preferred material for these members is structural steel tubing of square or rectangular cross section or other structural steel shapes such as angles or channel. As an alternative, structural aluminum members could be used. Also shown as being supported on the bottom deck 6 is a piece of rolling equipment 46 which by example could be a golf cart, lawn tractor, motorcycle or other similar device which could be rolled onto the lower deck 6 from the floor 2 when the liftable 4 frame is raised so that the bottom deck is even with the floor 2. It is understood that the liftable frame 4 could be designed to receive an automobile on the bottom deck 6 and the liftable frame 4 could be built to a greater or lesser size than generally depicted in FIG. 5.

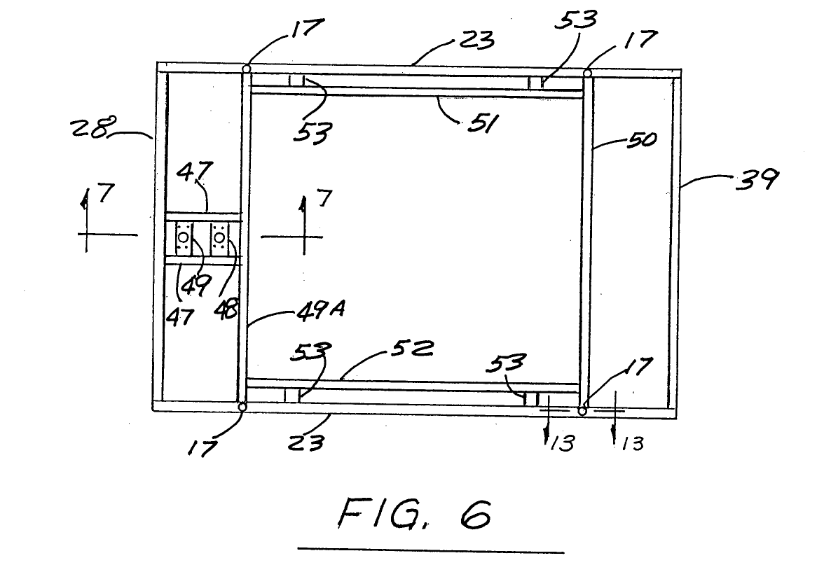

FIG. 6, a sectional view taken upon line 6-6 of FIG. 5, depicts the bottom members of the support frame 16 comprising bottom side beams 23, rear end bottom beam 28, front end bottom beam 39, bearing support beams 47, lower bearing support 48, reduction shaft bearing support 49, rear transverse chain guide brace 49A, front transverse guide brace 50, right longitudinal chain guide brace 51, left longitudinal chain guide brace 52 and spacer bars 53. A preferred material for these members is structural steel tubing of square or rectangular cross section or other structural steel shapes such as angles or channel. As an alternative, structural aluminum members could be used. The location of the lifting screw shafts 17 are also depicted in FIG. 6 without the other elements which comprise a mechanism for raising and lowering the liftable frame 4 through the opening 3 in the floor 2.

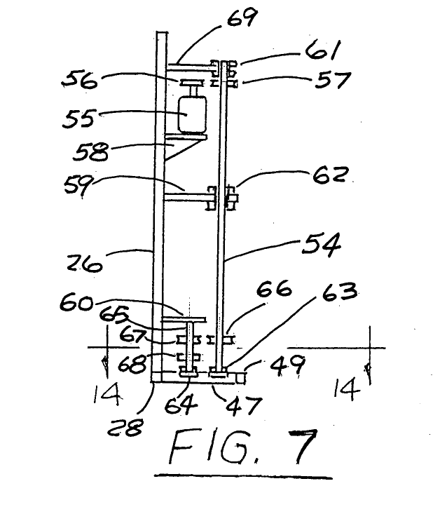

FIG. 7, A sectional view is taken along line 7-7 of FIG. 6 depicts several elements which comprise a mechanism for raising and lowering the liftable frame 4 through the opening 3 in the floor 2. Various elements of the rear end of the support frame 16 are seen in FIG. 7. Shown are a rear end column 26, a rear end bottom beam 28, a bearing support beam 47, and rear transfer chain guide brace 49A.

Shown as elements which partially comprise a mechanism for raising and lowering the liftable frame 4 are a motor 55 set on a support bracket 58 and driving a v-belt pulley 56 which in turn is driving an upper v-belt pulley 57 on the primary drive shaft 54. For purposes of simplicity, v-belts are not shown in the figure. The primary drive shaft 54 supported by an upper bearing 61, a center bearing 62, and a lower bearing 63. The upper bearing 61 is supported by a support bracket 69. The center bearing 62 is supported by a support bracket 59, the lower bearing 63 is supported by lower bearing support 48 shown in FIG. 6, which support 48 is in turn supported by bearing support beams 47. A lower chain drive sprocket 66 mounted on the primary drive shaft 54 drives a driven chain drive sprocket 67 mounted on a reduction shaft 65 supported at its upper end by a support bracket 60 and on its lower end by a bearing 64 which is in turn supported by bearing support 49 supported by bearing support beams 47. The reduction shaft 65 is fitted with a driving chain drive sprocket 68. For purposes of simplicity, roller chain is not depicted in this figure.

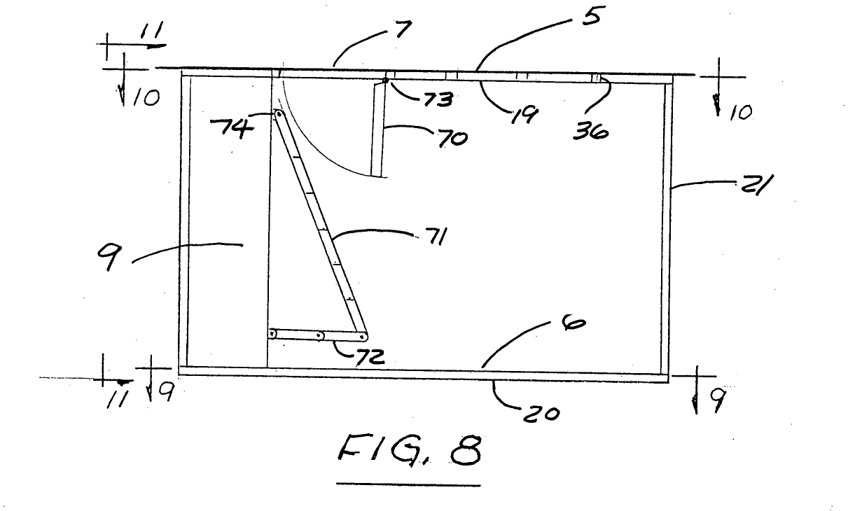

FIG. 8, a sectional view as taken along line 8-8 of FIG. 5 depicts a longitudinal cross section of the liftable frame 4. Shown are the top deck 5, a top deck longitudinal beam 19, top deck transverse beams 36, a front end support column 21, the bottom deck 6, a bottom deck longitudinal beam 20 and a safe 9. Also shown is an emergency exit hatch 7 with an emergency hatch door 70 in a lowered position on hinge 73. Also shown is a ladder 71 in an extended position on support brace 72 and pivot 74. It is intended that the ladder 71 can be swung on its pivot 74 and retracted to hang flush with the rear wall of the safe 9.

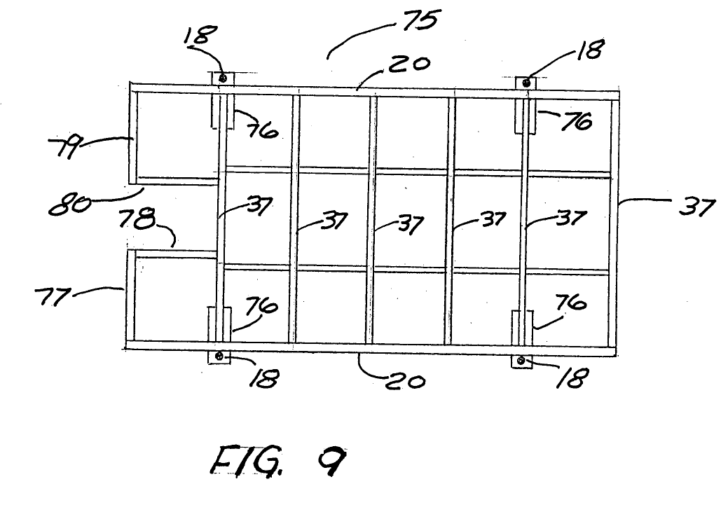

FIG. 9, a sectional view is taken along line 9-9 of FIG. 8 depicts the various members which provide support for the bottom deck 6. Shown are bottom deck longitudinal beams 20, bottom deck transverse beams 37, a longitudinal support beam 78 for a safe 9, a longitudinal support beam 80 for a storage compartment 10, a transverse support beam 77 for a safe 9 and a transverse support beam 79 for a storage compartment 10. A preferred material for these members is structural steel tubing of square or rectangular cross section or other structural steel shapes such as angles or channel. As an alternative, structural aluminum members could be used. Also shown are support plates 76 for ball screw nuts 18. As shown in FIG. 2, the ball screw nuts 18 are driver vertically on the lifting screw shaft 17. As shown in FIG. 5, the bottom deck 6 and its framework shown in FIG. 9 are designed to support rolling equipment 46 as well as a safe 9 and a storage compartment 10 with contents.

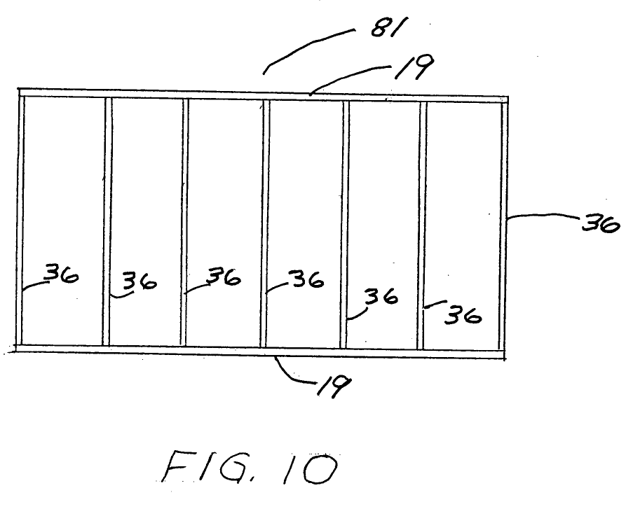

FIG. 10, a sectional view is taken along line 10-10 of FIG. 8 shows the top deck frame 81 comprising top deck longitudinal beams 19 and top deck transverse beams 36. A preferred material for these members is structural steel tubing of square or rectangular cross section or other structural steel shapes such as angles or channel. As an alternative, structural aluminum members could be used. In this embodiment it is intended that the top deck frame 81 and the top deck 7 be designed to support normal floor loads for the structure in which the concealed storage system 1 is installed. By way of example, if the concealed storage system 1 were installed on the floor 2 of a garage structure then the top deck 5, its support frame 81, in connection with support columns 21 and other structures such as a safe 9 in the storage compartment 10 should support normal garage floor loads such as an automobile.

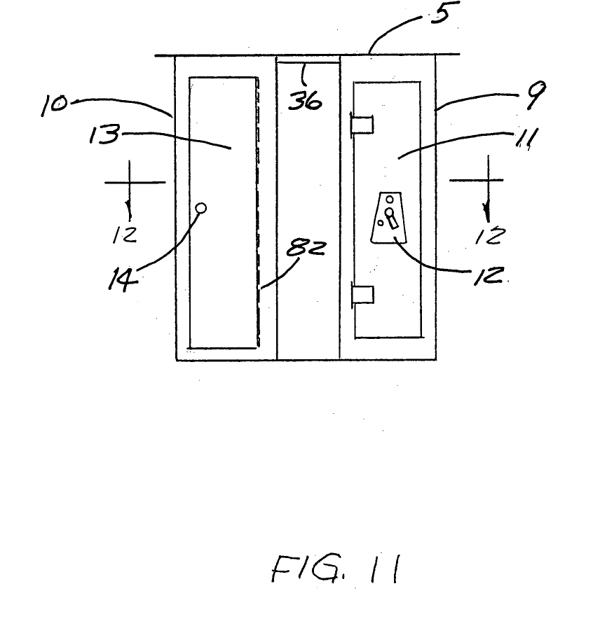

FIG. 11, a view as taken along a line 11-11 of FIG. 8 depicts a view of the liftable frame 4 from its rear end 43. Shown at the top deck 5 is a top deck transverse beam 36. Also shown is a safe 9 with a locking door 11 and recess lock 12. Shown also is a storage compartment 10 with a hinge door 13 and a tubular key lock 14. The hinge door 13 swings on a piano hinge 82. Although not shown it is intended that the locking mechanism for the safe 9 have multiple pin engagement at the top and bottom and both sides of the locking door.

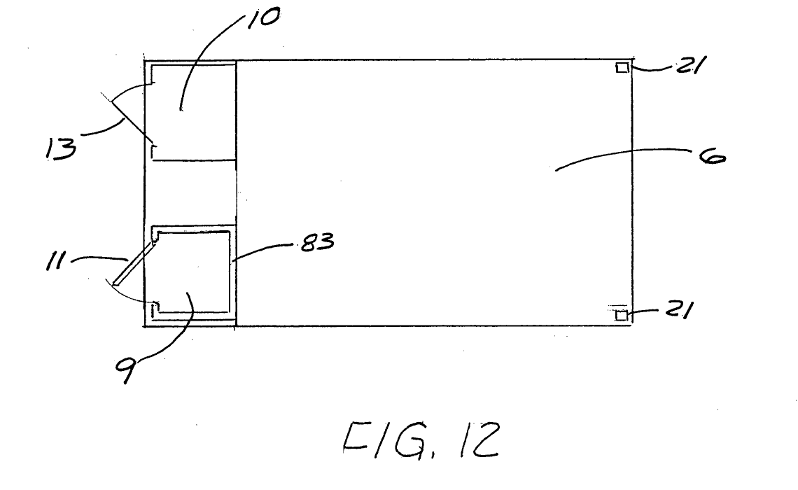

FIG. 12, a sectional view is taken along line 12-12 of FIG. 11 provides a horizontal cross section of the liftable frame 4 and shows the bottom deck 6, the front end support columns 21 in cross section and the safe 9 and the storage compartment 10 in cross section. The hinged door 13 of the storage compartment 10 is shown as well as the locking door 11 of the safe. In this embodiment it is also intended that the safe be fitted with a double wall 83.

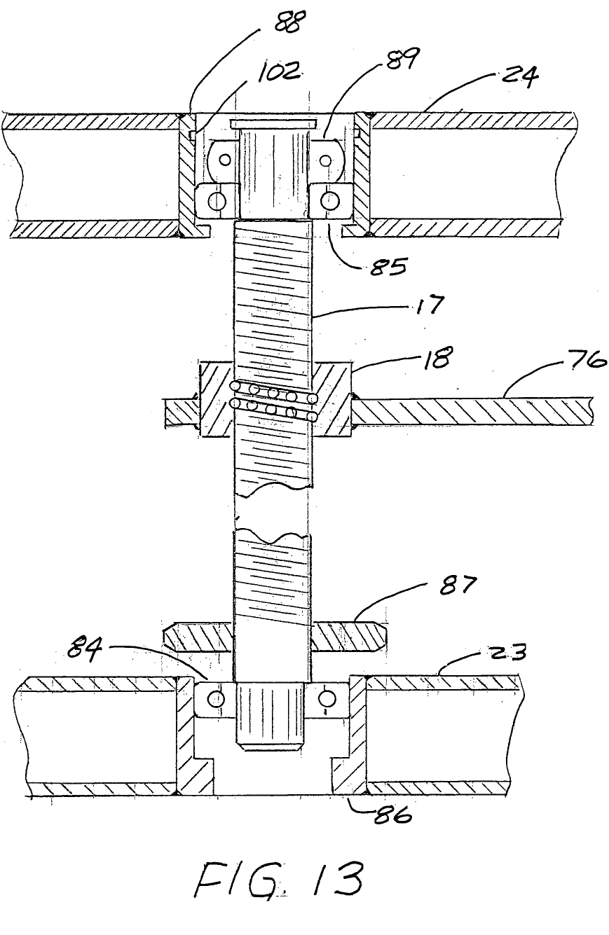

FIG. 13, a sectional view is taken along line 13-13 of FIG. 6 generally depicts those elements which directly raise and lower the liftable frame 4. FIG. 13 generally depicts elements pertaining to one lifting screw shaft 17 but it is intended that the elements shown would be identical at each lifting screw shaft 17. In the embodiment as shown, the lifting screw shaft 17 is suspended from a top side beam 24 of the support frame 16, a two piece collar 89 supports the lifting screw shaft 17 over an upper bearing 85 mounted in an upper bearing holder 88 affixed to the top side beam 24. Although for simplicity a snap ring is not shown, a snap ring groove 101 is created in the upper bearing holder 81 for the engagement of a snap ring. At its lower end the lifting screw shaft 17 rides in a lower bearing 84 set in a lower bearing holder 86 affixed to a bottom side beam 83 of the support frame 16. The lifting screw shaft 17 is turned by a chain drive sprocket 87. When turned, the lifting screw shaft activates a ball screw nut 18 which is permanently affixed to a support plate 76 which is part of the bottom deck frame 75 of the liftable frame 4. Hence, rotation of the lifting screw shaft 17 causes the ball screw nut 18 to move vertically along the longitudinal axis of the lifting screw shaft 17 thereby causing vertical motion of the liftable frame 4.

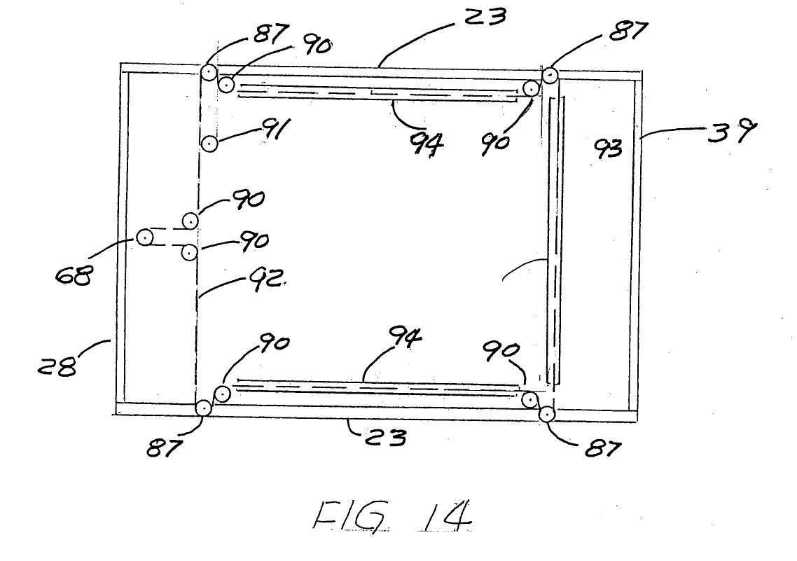

FIG. 14, a sectional view is taken along line 14-14 of FIG. 7 generally depicts the path of the roller chain 92 being moved by the driving chain drive sprocket 68 on the reduction shaft 65 and ultimately driving the lifting screw shafts 17 through the chain drive sprocket 87 as shown in FIG. 13. The path of roller chain 92 as shown in FIG. 14 is shown in relation to the bottom members of support frame 16 comprising front and bottom beam 39, rear end bottom beam 28, and bottom side beams 23. The roller chain 92 rides over idler sprockets 90 and is kept in tension with a tensioner sprocket 91. Chain rides through longitudinal guides 94 and a transverse guide 93.

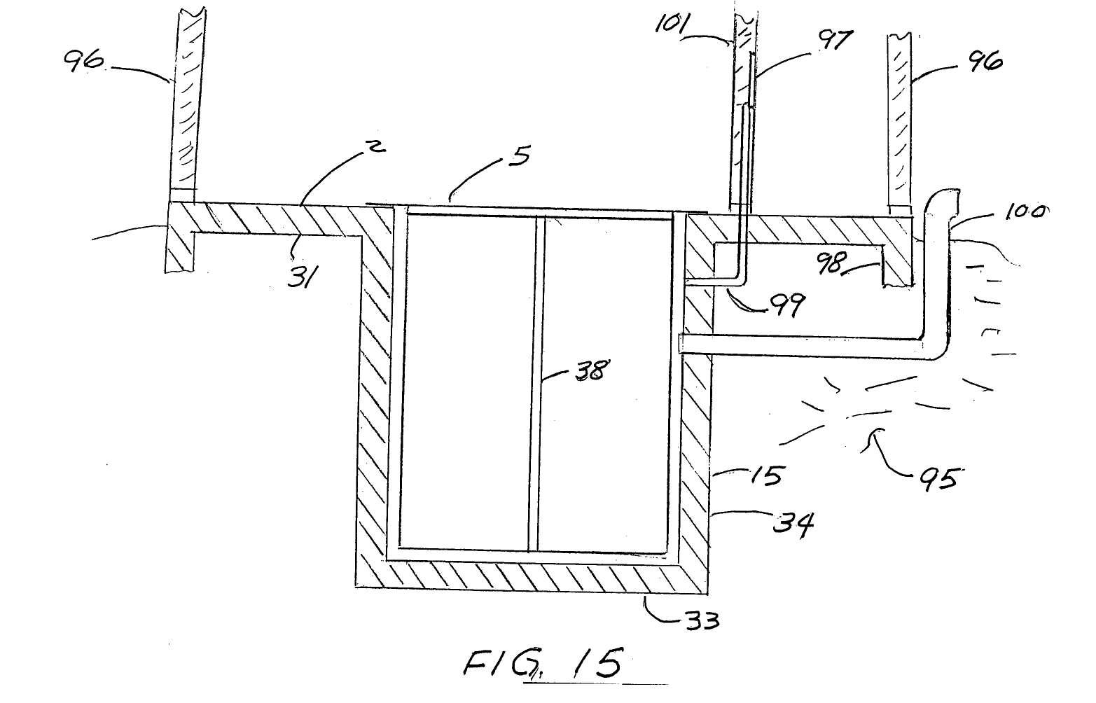

FIG. 15 is an additional sectional view as taken along line 4-4 of FIG. 2 showing a general cross section of he concealed storage system 1 in a lowered position with the top deck 5 flush with the floor 2 in addition to a floor slab 31, a chamber side structure 34 and chamber bottom structure 33. Other elements which might be incorporated in the encased chamber 15 comprise of vent pipe and/or sump pump connection 100 to provide ventilation and drainage to the encased chamber and needed and depending upon the conditions in the soil 95 surrounding the encased chamber 15. Also shown is a power supply conduit 99 running to a power supply panel 97 set on an interior wall 101 of a structure. Also shown for illustrative purposes are exterior walls 96 and a footing 98.

The embodiment of a concealed storage system and a mechanism for vertically raising and lowering the liftable frame through the opening in the floor as generally depicted in the figures, is representative of full scale experimentation by the inventors. Through this experimentation, the inventors have discovered that a 3 horsepower electric motor 55 powering a drive train as configured and illustrated in FIG. 7, driving size No. 50 roller chain 92 in the path illustrated in FIG. 14, in turn rotating four (4) lifting screw shafts 17 of one inch nominal diameter by chain drive sprockets 87 as depicted in FIG. 13, a liftable frame 4 with a bottom deck 6 capacity of 2000 pounds could be lifted a distance of approximately six (6) feet in 70 seconds. It is understood that the invention is not limited to these details and that the various elements, dimensions and materials may be changed to suit a specific application.

Although the present invention has been described with reference to the illustrated embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A concealed storage system comprising:
a. an encased chamber below a floor of a structure having an opening in said floor above the chamber;
b. a support frame fixed in the chamber;
c. a liftable frame within the support frame; said liftable frame further comprising a top deck and a bottom deck;
d. a mechanism for vertically raising and lowering the liftable frame through the opening in the floor.

2. The concealed storage system of claim 1 wherein the top deck of the liftable frame further comprises an emergency exit hatch.

3. The concealed storage system of claim 1 wherein the mechanism for raising and lowering the liftable frame through the opening in the floor further comprises a motor driving a roller chain and sprocket assembly, at least one lifting screw shaft driven by the roller chain and sprocket assembly and one ball screw nut affixed to the liftable frame for each lifting screw shaft wherein said ball screw nut is driven in a vertical direction by the lifting screw shaft.

4. The concealed storage system of claim 2 wherein the mechanism for raising and lowering the liftable frame through the opening in the floor further comprises a motor driving a roller chain and sprocket assembly, at least one lifting screw shaft driven by the roller chain and sprocket assembly and one ball screw nut affixed to the liftable frame for each lifting screw shaft wherein said ball screw nut is driven in a vertical direction by the lifting screw.

5. The concealed storage system of claim 3 wherein the mechanism for raising and lowering the liftable frame through the opening in the floor further comprises a primary drive shaft being rotated by the motor through a belt and pulley assembly, said primary drive shaft driving the roller chain and sprocket assembly.

6. The concealed storage system of claim 4 wherein the mechanism for raising and lowering the liftable frame through the opening in the floor further comprises a primary drive shaft being rotated by the motor through a belt and pulley assembly, said primary drive shaft driving the roller chain and sprocket assembly.

7. The concealed storage system of claim 1 wherein the top deck of the liftable frame is of size and shape to cover the opening in the floor when the liftable frame is vertically lowered fully in the support frame and wherein the bottom deck of the liftable frame is even with the floor when the liftable frame is vertically raised fully in the support frame.

8. The concealed storage system of claim 7 wherein the top deck of the liftable frame further comprises an access hatch for emergency entrance and exit.

9. The concealed storage system of claim 8 wherein the liftable frame further comprises a front end, a rear end, a right side and a left side, and further comprises a safe with a locking door mounted between the bottom deck and the upper deck at the rear end of the liftable frame with the locking door facing the rear end of the liftable frame and accessible from the floor at the rear end of the liftable frame when the liftable frame is vertically raised fully in the support frame and the bottom deck is even with the floor, and further comprising a storage compartment with a hinged door mounted between the bottom deck and the upper deck at the rear end of the liftable frame with the hinged door facing the rear end of the liftable frame and accessible from the floor at the rear end of the liftable frame when the liftable frame is vertically raised fully in the support frame and the bottom deck is even with the floor.

10. The concealed storage system of claim 9 wherein the mechanism for raising and lowering the liftable frame through the opening in the floor further comprises a motor driving a roller chain and sprocket assembly, at least one lifting screw shaft driven by the roller chain and sprocket assembly and one ball screw nut affixed to the liftable frame for each lifting screw shaft wherein said ball screw nut is driven in a vertical direction by the lifting screw.

11. The concealed storage system of claim 10 wherein the mechanism for raising and lowering the liftable frame through the opening in the floor further comprises a primary drive shaft being rotated by the motor through a belt and pulley assembly, said primary drive shaft driving the roller chain and sprocket assembly.

12. The concealed storage system of claim 7 wherein the bottom deck is of size and shape to receive and store rolling equipment from the floor when the bottom deck is even with the floor.

13. The concealed storage system of claim 12 wherein the top deck of the liftable frame further comprises an access hatch for emergency entrance and exit.

14. The concealed storage system of claim 12 wherein the liftable frame further comprises a front end, a rear end, a right side and a left side, and further comprises a safe with a locking door mounted between the bottom deck and the upper deck at the rear end of the liftable frame with the locking door facing the rear end of the liftable frame and accessible from the floor at the rear end of the liftable frame when the liftable frame is vertically raised fully in the support frame and the bottom deck is even with the floor, and further comprising a storage compartment with a hinged door mounted between the bottom deck and the upper deck at the rear end of the liftable frame with the hinged door facing the rear end of the liftable frame and accessible from the floor at the rear end of the liftable frame when the liftable frame is vertically raised fully in the support frame and the bottom deck is even with the floor.

15. The concealed storage system of claim 14 wherein the mechanism for raising and lowering the liftable frame through the opening in the floor further comprises a motor driving a roller chain and sprocket assembly, at least one lifting screw shaft driven by the roller chain and sprocket assembly and one ball screw nut affixed to the liftable frame for each lifting screw shaft wherein said ball screw nut is driven in a vertical direction by the lifting screw.

16. The concealed storage system of claim 15 wherein the mechanism for raising and lowering the liftable frame through the opening in the floor further comprises a primary drive shaft being rotated by the motor through a belt and pulley assembly, said primary drive shaft driving the roller chain and sprocket assembly.

17. The concealed storage system of claim 1 wherein the mechanism for raising and lowering the liftable frame through the opening in the floor comprises at least one control switch within the liftable frame and at least one control switch external to the liftable frame.

18. A method for creating a concealed storage system comprising the steps of:
a. excavating and encasing a chamber below a floor in a structure with an opening in said floor;
b. fabricating and fixing a support frame in the chamber;
c. fabricating and installing a liftable frame with a top deck and a bottom deck to travel vertically in the support frame;
d. providing and installing a mechanism for vertically raising and lowering the liftable frame in the support frame through the opening in the floor.

19. The method of claim 18 further comprising the step of installing an access hatch in the top deck for emergency entrance and exit.

20. The method of claim 19 further comprising the step of fabricating and installing a liftable frame wherein the top deck of the liftable frame is of size and shape to cover the opening in the floor when the liftable frame is vertically lowered fully in the support frame and wherein the bottom deck of the liftable frame is even with the floor when the liftable frame is vertically raised fully in the support frame.

21. The method of claim 20 further comprising the step of fabricating and installing a liftable frame wherein the liftable frame comprises a front end, a rear end, a right side and a left side, and further comprises a safe with a locking door mounted between the bottom deck and the upper deck at the rear end of the liftable frame with the locking door facing the rear end of the liftable frame and accessible from the floor at the rear end of the liftable frame when the liftable frame is vertically raised fully in the support frame and the bottom deck is even with the floor, and further comprising a storage compartment with a hinged door mounted between the bottom deck and the upper deck at the rear end of the liftable frame with the hinged door facing the rear end of the liftable frame and accessible from the floor at the rear end of the liftable frame when the liftable frame is vertically raised fully in the support frame and the bottom deck is even with the floor.

22. The method of claim 20 wherein the bottom deck is of size and shape to receive and store rolling equipment from the floor when the bottom deck is even with the floor.

23. The method of claim 18 wherein the mechanism for raising and lowering the liftable frame through the opening in the floor further comprises a motor driving a roller chain and sprocket assembly, at least one lifting screw shaft driven by the roller chain and sprocket assembly and one ball screw nut affixed to the liftable frame for each lifting screw shaft wherein said ball screw nut is driven in a vertical direction by the lifting screw.

24. The method of claim 23 wherein the mechanism for raising and lowering the liftable frame through the opening in the floor further comprises a primary drive shaft being rotated by the motor through a belt and pulley assembly, said primary drive shaft driving the roller chain and sprocket assembly.

25. The method of claim 18 wherein the mechanism for raising and lowering the liftable frame through the opening in the floor comprises at least one control switch within the liftable frame and at least one control switch external to the liftable frame.
